(19) United States
(12) Patent Application Publication
(10) Pub. No.: US 2016/0093190 A1
(43) Pub. Date: Mar. 31, 2016

(54) APPARATUS AND METHOD FOR AUGMENTED COGNITION

(71) Applicant: ELECTRONICS AND TELECOMMUNICATIONS RESEARCH INSTITUTE, Daejeon (KR)

(72) Inventors: Sun-Jin KIM, Daejeon (KR); Tae-Joon PARK, Daejeon (KR); Myung-Nam BAE, Daejeon (KR); Hoe-Sung YANG, Daejeon (KR); Mal-Hee KIM, Daejeon (KR); Dong-Hwan PARK, Daejeon (KR); Hyo-Chan BANG, Daejeon (KR)

(21) Appl. No.: 14/745,294

(22) Filed: Jun. 19, 2015

(30) Foreign Application Priority Data
Sep. 25, 2014 (KR) 10-2014-0128618

(51) Int. Cl. G08B 21/04

(52) U.S. Cl. CPC G08B 21/0438

(57) ABSTRACT

The present invention relates to an apparatus and a method for augmented cognition that can improve the cognitive ability of a worker by collecting various sensed data in a work place, generating artificial sensory information based on the collected sensed data, and providing the generated artificial sensory information in the form of an augmented cognition service.

### CROSS-REFERENCE TO RELATED APPLICATIONS

This application claims the benefit of Korean Patent Application No. 10-2014-0128618, filed with the Korean Intellectual Property Office on Sep. 25, 2014, the disclosure of which is incorporated herein by reference in its entirety.

### BACKGROUND

1. Technical Field

The disclosed embodiments relates to an apparatus and a method for augmented cognition, more specifically to an apparatus and a method for augmented cognition that can improve the cognitive ability of a worker.

2. Background Art

Workers exposed to dire environments, such as the scene of a fire, have more than 90% of their vision deteriorated and lose their hearing to 1/1000 of the normal level, not to mention that their tactile and olfactory senses are completely useless due to the fireproof gears that they wear. Moreover, the blunted bodily sensation drops the cognitive ability of the worker dramatically and increases the psychological pressure, leading the worker to lose the sense of location or direction and resulting in the loss of life in the worst case.

With the increased need for a national-level disaster preparation system for allowing the citizens to enjoy safety even under uncertain circumstances like natural disasters and accidents, the firefighting scenes increasingly and urgently require augmented cognition services that allow for recognition of risk factors, provide secure return path and enable an active management of situations in dire environments in which the infrastructure is lost.

For this, technologies would need to rapidly improve the cognitive ability of the worker based on artificial sensory information generated in real time by interconnecting, through a network, conventional work tools, devices and environmental sensors with indoor pedestrian dead reckoning (PDR) that is still available in infra-less circumstances to which the conventional position tracking technology requiring a communication infrastructure cannot be applied.

### SUMMARY

Accordingly, the disclosed embodiments provides an apparatus and a method for augmented cognition that can improve the cognitive ability of a worker, even in an extremely dire circumstance, by collecting surrounding environment information required for responding to a disaster, generating artificial sensory information based on the collected information, and providing the artificial sensory information to the worker in the form of an augmented cognition service.

An aspect of the present invention features an apparatus for augmented cognition. The apparatus for augmented cognition in accordance with an embodiment of the present invention includes: an artificial sensory generating module configured to generate individual artificial sensory information by use of work-related information and sensed data collected through at least one of an IoT device and a sensor; an artificial sensory transferring module configured to transfer the individual artificial sensory information to another augmented cognition apparatus or receive artificial sensory information generated by said another augmented cognition apparatus; an artificial sensory converging module configured to generate converged artificial sensory information by converging at least one of the generated individual artificial sensory information and the artificial sensory information received from said another augmented cognition apparatus; and an augmented cognition module configured to convert the converged artificial sensory information to a sensory information that is optimized for a user and to provide the converted sensory information in the form of an augmented cognition service.

In an embodiment, the IoT device may be connected to the apparatus for augmented cognition through IoT(Internet of Things)/M2M (Machine-To-Machine) communication.

In an embodiment, the sensor may be mounted on the apparatus for augmented cognition or connected to the apparatus for augmented cognition through IoT/M2M communication.

In an embodiment, the individual artificial sensory information may include at least one of a sense of danger, a sense of location and a sense of route.

In an embodiment, the artificial sensory transferring module may be configured to use an ad-hoc network in order to communicate with said another augmented cognition apparatus.

In an embodiment, the artificial sensory converging module may be configured to primarily converge the individual artificial sensory information generated by the artificial sensory generating module and to generate converged artificial sensory information by secondarily converging the artificial sensory information received from said another augmented cognition apparatus with the primarily-converged artificial sensory information.

In an embodiment, the augmented cognition module may be configured to provide the converged artificial sensory information in the form of an augmented cognition service by converting the converged artificial sensory information to at least one of visual information, acoustic information and haptic information.

Another aspect of the present invention features a method for providing an augmented cognition service in an apparatus for augmented cognition. The method for providing an augmented cognition service in accordance with an embodiment of the present invention includes: collecting sensed data through at least one of an IoT device and a sensor; generating individual artificial sensory information by using the collected sensed data and work-related information; generating primarily-converged artificial sensory information by analyzing and combining the individual artificial sensory information; exchanging and sharing the primarily-converged artificial sensory information with another augmented cognition apparatus; secondarily converging the artificial sensory information received from said another augmented cognition apparatus with the primarily-converged artificial sensory information; converting the secondarily-converged artificial sensory information to sensory information optimized for a user; and providing the converted sensory information in the form of a UI/UX-based augmented cognition service.

In an embodiment, the individual artificial sensory information may include at least one of a sense of danger, a sense of location and a sense of route.

In an embodiment, the IoT device may be connected to the apparatus for augmented cognition through IoT(Internet of Things)/M2M (Machine-To-Machine) communication.

In an embodiment, the exchanging and sharing of the primarily-converged artificial sensory information with said another augmented cognition apparatus may include communicating with said another augmented cognition apparatus by use of an ad-hoc network.

According to an embodiment of the present invention, mountable-sized sensors are mounted on an augmented cognition apparatus, such as a helmet, and other tools are connected with the augmented cognition apparatus through IoT/M2M communication, allowing the augmented cognition apparatus to collect surrounding environment information in real time, to analyze the collected surrounding environment information and generate and provide situation information, such as a risk of explosion, biological risk and indoor path, to a worker in the form of artificial sensory information. Specifically, the artificial sensory information may be provided to the worker as information that has become visible through a display device of the augmented cognition apparatus, audible through a speaker/earphone, or haptic using a vibrator. Accordingly, the worker can focus on the assigned task because the provided information may be used for his or her decision making.

The functions of generating and transferring the artificial sensations in accordance with an embodiment of the present invention in an environment in which the infrastructure is lost are expected to be utilized not only for responding to disasters, such as fire, explosion and collapse, but also for the field of occupational safety in many industrial environments of the plant, construction and chemical industries, as well as for various indoor location-based services targeted for the general public. Moreover, the modules of the augmented cognition apparatus may be utilized with various wearable devices, which have been emerging recently.

By introducing the augmented cognition apparatus in accordance with an embodiment of the present invention, fire-fighters will be better protected and fear less about the possibility of accidents, eventually reducing the fatality of the fire-fighters. Furthermore, the improved safety of the fire-fighters will improve the fire-fighting efficiency and result in the reduced loss of life and property of the general population. Moreover, the present invention can contribute to reducing industrial hazards, by utilizing the present invention for the protection and safety of industrial workers.

Furthermore, as the present invention allows for an assessment of danger and location in extreme environments, the present invention can be utilized in military and police operations and for development of protective industrial gears.

### BRIEF DESCRIPTION OF DRAWINGS

FIG. 1 illustrates an environment in which an apparatus for augmented cognition is implemented in accordance with an embodiment of the present invention.

FIG. 2 shows how IoT devices and sensors are connected to an apparatus for augmented cognition in accordance with an embodiment of the present invention.

FIG. 3 is a block diagram illustrating the configuration of an apparatus for augmented cognition in accordance with an embodiment of the present invention.

FIG. 4 is a flow diagram illustrating a method of providing an augmented cognition service in an apparatus for augmented cognition in accordance with an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Throughout the description of the present invention, when describing a certain relevant conventional technology is determined to evade the point of the present invention, the pertinent detailed description will be omitted.

Unless otherwise stated, any expression in singular form in the description and the claims shall be interpreted to generally mean “one or more.”

Moreover, any terms “module,” “unit,” “interface,” etc. used in the description shall generally mean computer-related objects and can mean, for example, hardware, software and a combination thereof.

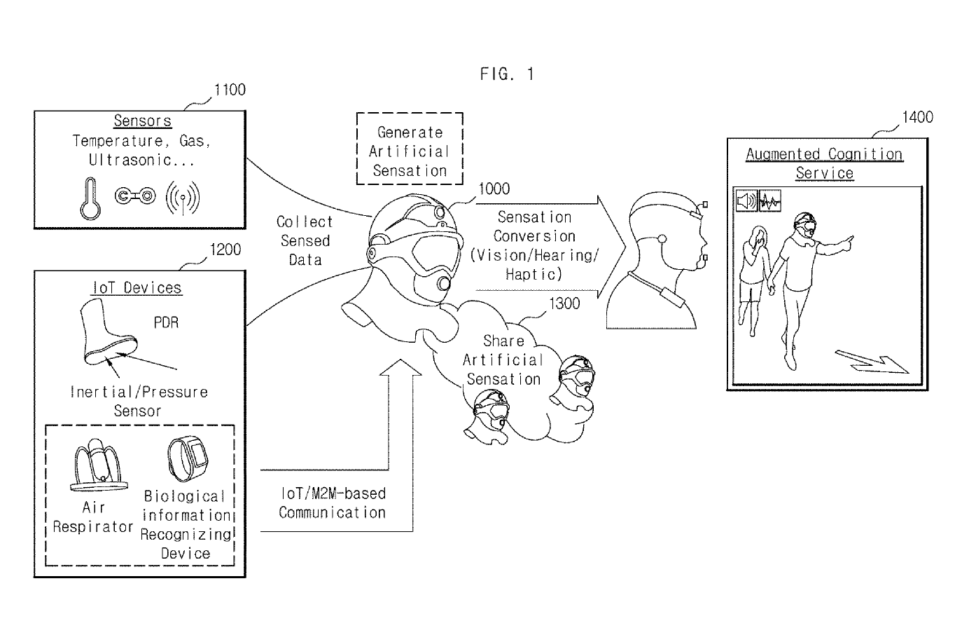

Hereinafter, various embodiments of the present invention will be described with reference to FIG. 1 to FIG. 4.

FIG. 1 illustrates an environment in which an apparatus for augmented cognition is implemented in accordance with an embodiment of the present invention. Although the apparatus for augmented cognition is implemented in the form of a helmet 1000 in the example shown in FIG. 1, it shall be appreciated by anyone of ordinary skill in the art that the present invention is not limited to the form that is described and illustrated herein.

As illustrated, various mountable-sized sensors 1100 (e.g., temperature sensor, gas sensor, ultrasonic sensor, etc.) for collecting surrounding environment information may be mounted on an augmented cognition apparatus 1000 in order to supplement blunted senses of a worker. In the meantime, IoT (Internet of Things) devices 1200, including conventional rescue equipment, such as fire-fighting devices including an air respirator and fire-fighting boots to which an inertial sensor is attached for obtaining Pedestrian Dead Reckoning (PDR) information, or a biological information recognizing device may be connected to the augmented cognition apparatus 1000 through wireless IoT/M2M (Machine To Machine) communication.

Through this M2M connectivity, the augmented cognition apparatus 1000 may collect various sensed data in real time, process and analyze the collected sensed data and generate artificial sensory information for realms such as an explosion risk sense, a biological risk sense and a return sense that cannot be cognized by a human being.

The augmented cognition apparatus 1000 may convert the artificial sensory information to sensory information such as vision/hearing/tactile senses that can be easily cognized by a human being and provide an augmented cognition service 1400, for example, guiding a return path, to the worker (i.e., a person wearing the helmet).

Moreover, by building a reliable distributed network 1300, the augmented cognition apparatus 1000 may exchange and share the artificial sensory information with other augmented cognition apparatuses. Through the reliable distributed network 1300, the augmented cognition apparatus 1000 may continuously assess communicable subjects around the augmented cognition apparatus 1000 in an environment where no communication infrastructure is present and the workers are freely moving around, dynamically perform a change of network topology pursuant to the moving, and perform communication with another worker. Accordingly, the augmented cognition apparatus 1000 may share information with other apparatuses and converge with more information that is not collected by the augmented cognition apparatus 1000.

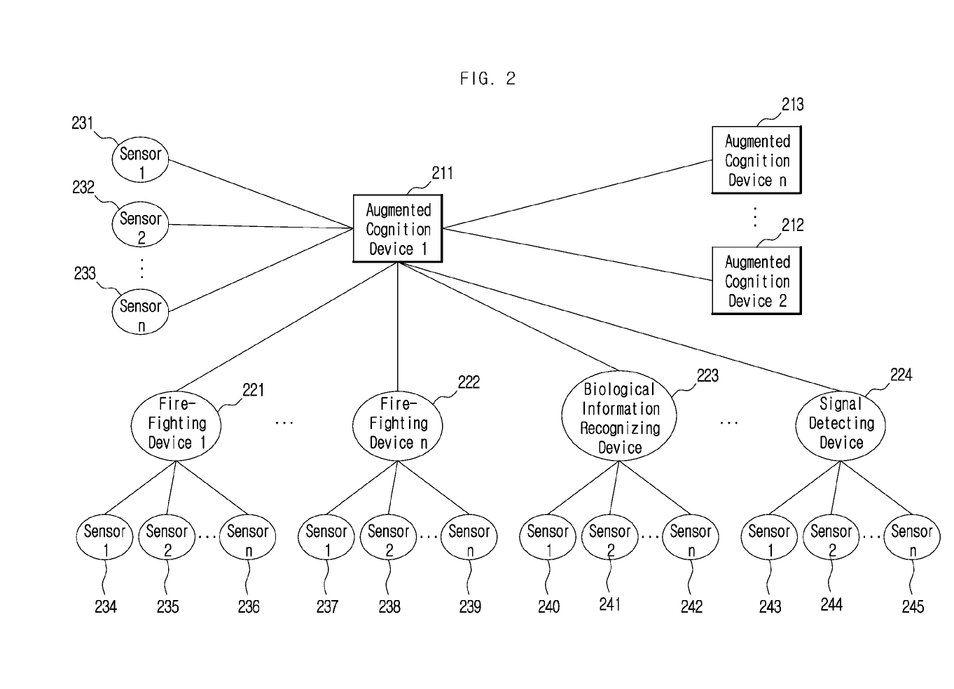

FIG. 2 shows how IoT devices and sensors are connected to an apparatus for augmented cognition in accordance with an embodiment of the present invention.

As illustrated, an augmented cognition apparatus 211 may have sensors 231-233 and various IoT devices 221-224, such as a fire-fighting device, a biological information recognizing device, a signal detecting device, etc., connected thereto. The IoT devices 221-224 may each have a sensor and a process algorithm that are suitable for its own purpose and function.

In an embodiment, the augmented cognition apparatus 211, 212, 213 may each include an individual sensor that is directly attached thereto in the form of a patch or an implant, as necessary.

In an embodiment, the augmented cognition apparatuses 211, 212, 213 may be connected through a reliable distributed network in order to transfer and share artificial sensory information with one another. Here, the augmented cognition apparatuses 211, 212, 213 may be connected with one another by use of an ad-hoc network, which is an infra-less communication network.

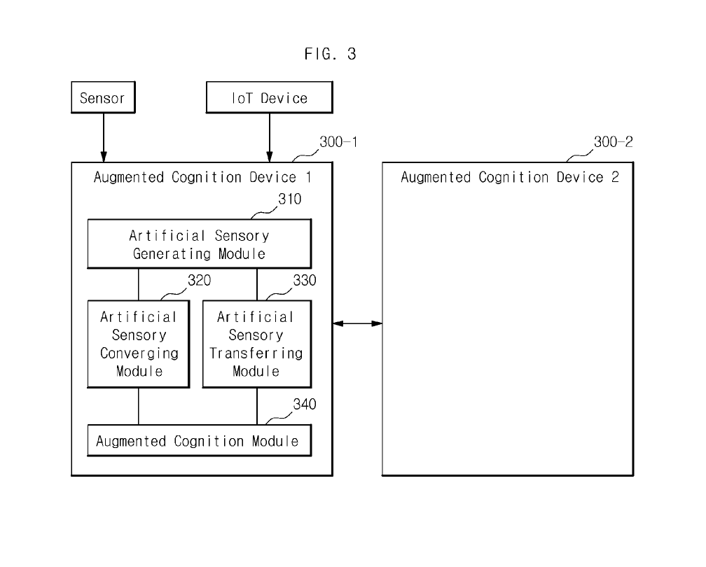

FIG. 3 is a block diagram illustrating the configuration of an apparatus for augmented cognition in accordance with an embodiment of the present invention. Although FIG. 3 shows elements constituting an augmented cognition apparatus 1 300-1 only, it shall be appreciated that an augmented cognition apparatus 2 300-2 may be constituted with substantially the same elements.

As illustrated in FIG. 3, the augmented cognition apparatus 1 300-1 may be physically connected directly or indirectly with IoT devices, such as a fire-fighting device, a biological information recognizing device, a signal detecting device, etc., and/or various sensors to collect various sensed data, such as biological information and signal information detected in connection with a task, in real time.

The augmented cognition apparatus 1 300-1 may process the sensed data collected in real time to generate artificial sensory information and may converge the generated artificial sensory information to generate new artificial sensory information. Moreover, the augmented cognition apparatus 1 300-1 may share the artificial sensory information by transferring the generated artificial sensory information to another augmented cognition apparatus 300-2 that cooperates with the augmented cognition apparatus 1 300-1 in the work site. An enhanced and improved augmentation of cognition is possible through the transfer and sharing of the artificial sensory information.

In an embodiment, the augmented cognition apparatus 1 300-1 may include an artificial sensory generating module 310, an artificial sensory converging module 320, an artificial sensory transferring module 330 and an augmented cognition module 340.

The artificial sensory generating module 310 generates artificial sensory information by using work-related information and sensed data collected from the work site through various IoT devices and sensors.

The artificial sensory generating module 310 may generate the artificial sensory information required for the work (e.g., fire-fighting) by using the work-related information (e.g., an interior map of a building, coordinate information, etc.), which is collected (or downloaded) before being put into the work site, together with the sensed data collected in the work site. The artificial sensory information generated by the artificial sensory generating module 310 may include individual senses in heterogeneous forms, for example, a five senses-type artificial sensation such as vision or sensory information in the form of a sense of danger, a sense of location or a sense of route.

The artificial sensory converging module 320 may improve the individual senses by storing the individual artificial sensory information generated by the artificial sensory generating module 310 in a local storage (not shown) and then converging (primary convergence) the stored individual artificial sensory information later according to a purpose or a situation of the work site. The primary convergence refers to convergence of artificial sensory information generated within a single augmented cognition apparatus 300-1 or 300-2, is performed by applying the generated artificial sensory information to a moving path of the augmented cognition apparatus.

In an embodiment, in addition to the primary convergence of the individual artificial sensory information stored in the local storage, the artificial sensory converging module 320 may generate artificial sensory information, of which the realm of cognition is further expanded, by secondarily converging the artificial sensory information transferred from another augmented cognition apparatus (e.g., 300-2) with the primarily-converged artificial sensory information.

The artificial sensory transferring module 330 transfers artificial sensory information to another augmented cognition apparatus or receives artificial sensory information generated by another augmented cognition apparatus, in order to share the artificial sensory information with other augmented cognition apparatuses. The artificial sensory converging module 320 performs the secondary convergence through conversion and adaptation processes for making the received artificial sensory information compatible with its own artificial sensory information, and may expand the realm of cognition through this secondary convergence. In order to receive the artificial sensory information from other augmented cognition apparatuses, the artificial sensory transferring module 330 forms a reliable distributed network with other augmented cognition apparatuses. In an embodiment, used for communication among the augmented cognition apparatuses may be an ad-hoc network, which is an infra-less communication network.

The augmented cognition module 340 provides the primarily/secondarily converged artificial sensory information to the worker in the form of a UI/UX-based augmented cognition service by converting the primarily/secondarily converged artificial sensory information to sensory information that is optimized for a user, for example, visual sensation, acoustic sensation, haptic sensation, etc. That is, the artificial sensory information may be provided to the worker as information that has become visible through a display device of the augmented cognition apparatus, audible through a speaker/earphone, or haptic using a vibrator.

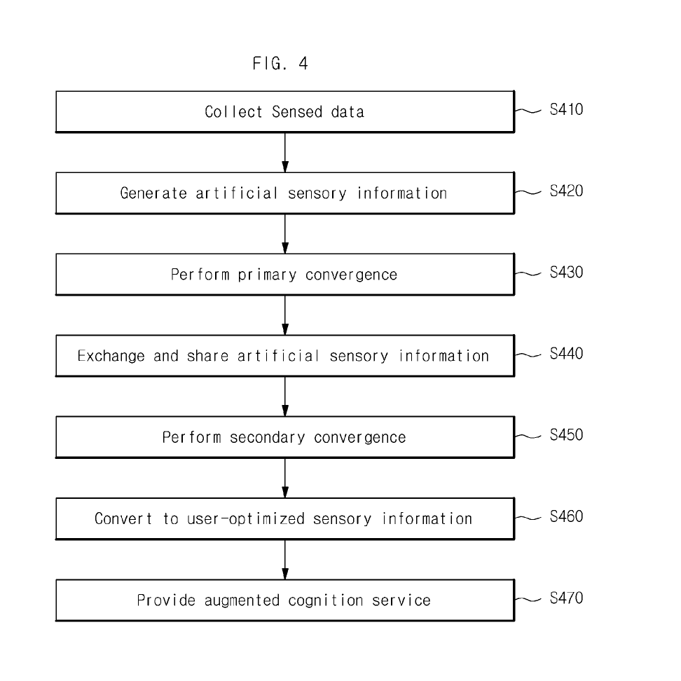

FIG. 4 is a flow diagram illustrating a method of providing an augmented cognition service in an apparatus for augmented cognition in accordance with an embodiment of the present invention.

In S410, sensed data is collected through various sensors and IoT devices that are connected to an augmented cognition apparatus directly or indirectly.

In S420, individual artificial sensory information, with which situation information can be assessed based on the collected sensed data and work-related information, is generated.

In S430, primary convergence is performed by analyzing and combining the individual artificial sensory information generated in the step of S420. The artificial sensory information generated through the primary convergence in the step of S430 is artificial sensory information generated by an augmented cognition apparatus of an individual worker, for example, the augmented cognition apparatus 1 300-1 shown in FIG. 3.

In S440, the individual artificial sensory information generated by the augmented cognition apparatus of the individual worker is exchanged and shared through communication among augmented cognition apparatuses.

In S450, artificial sensory information, of which the realm of cognition is expanded, is generated by secondarily converging the artificial sensory information transferred from other augmented cognition apparatus(es) with its own individual/converged artificial sensory information.

In S460, the converged artificial sensory information is converted to sensory information, such as visual/acoustic/haptic sensation, which is optimized for a user.

In S470, the converted sensory information is provided to the worker in the form of a multimodal UI/UX-based augmented cognition service.

With the present invention, two or more workers who are involved in an action in a scene of fire can exchange/share moving paths, which are artificial sensory information generated by the two individuals, to additionally secure a safe moving path. In other words, rather than a simple one-dimensional use of situation information, new artificial sensory information, of which the realm of cognition is expanded, is generated through various interpretations and multi-dimensional convergence.

The above-described embodiments of the invention may be implemented as a computer implemented method or as a non-transitory computer readable medium with computer executable instructions stored thereon. When executed by the processor, the computer readable instructions may perform a method according to at least one embodiment of the invention.

The program instructions stored in the computer readable medium can be designed and configured specifically for the present invention or can be publically known and available to those who are skilled in the field of software. Examples of the computer readable medium can include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions. Moreover, the above-described media can be transmission media, such as optical or metal lines and a waveguide, which include a carrier wave that transmits a signal designating program instructions, data structures, etc. Examples of the program instructions can include machine codes made by, for example, a compiler, as well as high-language codes that can be executed by an electronic data processing device, for example, a computer, by using an interpreter.

The above hardware devices can be configured to operate as one or more software modules in order to perform the operation of the present invention, and the opposite is also possible.

Hitherto, certain embodiments of the present invention have been described, and it shall be appreciated that a large number of permutations and modifications of the present invention are possible without departing from the intrinsic features of the present invention by those who are ordinarily skilled in the art to which the present invention pertains. Accordingly, the disclosed embodiments of the present invention shall be appreciated in illustrative perspectives, rather than in restrictive perspectives, and the scope of the technical ideas of the present invention shall not be restricted by the disclosed embodiments. The scope of protection of the present invention shall be interpreted through the claims appended below, and any and all equivalent technical ideas shall be interpreted to be included in the claims of the present invention.

What is claimed is:

1. An apparatus for augmented cognition, comprising:
an artificial sensory generating module configured to generate individual artificial sensory information by use of work-related information and sensed data collected through at least one of an IoT(Internet of Things) device and a sensor;
an artificial sensory transferring module configured to transfer the individual artificial sensory information to another augmented cognition apparatus or receive artificial sensory information generated by said another augmented cognition apparatus;
an artificial sensory converging module configured to generate converged artificial sensory information by converging at least one of the generated individual artificial sensory information and the artificial sensory information received from said another augmented cognition apparatus; and
an augmented cognition module configured to convert the converged artificial sensory information to a sensory information that is optimized for a user and to provide the converted sensory information in the form of an augmented cognition service.

2. The apparatus of claim 1, wherein the IoT device is connected to the apparatus for augmented cognition through IoT(Internet of Things)/M2M (Machine-To-Machine) communication.

3. The apparatus of claim 1, wherein the sensor is mounted on the apparatus for augmented cognition or connected to the apparatus for augmented cognition through IoT(Internet of Things)/M2M communication.

4. The apparatus of claim 1, wherein the individual artificial sensory information includes at least one of a sense of danger, a sense of location and a sense of route.

5. The apparatus of claim 1, wherein the artificial sensory transferring module is configured to use an ad-hoc network in order to communicate with said another augmented cognition apparatus.

6. The apparatus of claim 1, wherein the artificial sensory converging module is configured to primarily converge the individual artificial sensory information generated by the artificial sensory generating module and to generate converged artificial sensory information by secondarily converging the artificial sensory information received from said another augmented cognition apparatus with the primarily-converged artificial sensory information.

7. The apparatus of claim 1, wherein the augmented cognition module is configured to provide the converged artificial sensory information in the form of an augmented cognition service by converting the converged artificial sensory information to at least one of visual information, acoustic information and haptic information.

8. A method for providing an augmented cognition service in an apparatus for augmented cognition, the method comprising:
collecting sensed data through at least one of an IoT device and a sensor;
generating individual artificial sensory information by using the collected sensed data and work-related information;
generating primarily-converged artificial sensory information by analyzing and combining the individual artificial sensory information;
exchanging and sharing the primarily-converged artificial sensory information with another augmented cognition apparatus;
secondarily converging the artificial sensory information received from said another augmented cognition apparatus with the primarily-converged artificial sensory information;
converting the secondarily-converged artificial sensory information to sensory information optimized for a user; and
providing the converted sensory information in the form of a UI/UX-based augmented cognition service.

9. The method of claim 8, wherein the individual artificial sensory information includes at least one of a sense of danger, a sense of location and a sense of route.

10. The method of claim 8, wherein the IoT device is connected to the apparatus for augmented cognition through IoT(Internet of Things)/M2M (Machine-To-Machine) communication.

11. The method of claim 8, wherein the exchanging and sharing of the primarily-converged artificial sensory information with said another augmented cognition apparatus comprises communicating with said another augmented cognition apparatus by use of an ad-hoc network.
